(19) United States
(12) Patent Application Publication
(10) Pub. No.: US 2009/0106957 A1
(43) Pub. Date: Apr. 30, 2009

(54) Buckle device

(76) Inventor: Vincent Chang, Changhua (TW)

Correspondence Address: CHARLES E. BAXLEY, ESQUIRE, 90 JOHN STREET, SUITE 309, NEW YORK, NY, 10038, US

(21) Appl. No.: 11/980,932

(22) Filed: Oct. 31, 2007

(51) Int. Cl. B25B 25/00

(52) U.S. Cl. 24/68 CD

(57) ABSTRACT

A buckle device includes a base coupled to a strap, an operating arm is rotatably secured to the base with a stationary axle, a shaft is attached to the operating arm. A latch is slidably attached to the operating arm to selectively lock the operating arm to the base. Another strap has an intermediate portion engaged around the stationary axle to form two strap segments, the shaft may force the strap segment to tighten the straps when the operating arm is moved toward the base and locked to the base at the locking position with the latch, the stationary axle and the shaft are spaced from each other for a distance to allow one of the strap segments to be further pulled by a user and to further tighten the straps.

### BACKGROUND OF THE INVENTION

1. Field of the Invention

The present invention relates to a buckle device, and more particularly to a simplified buckle device for coupling or suspending straps and for anchoring and positioning the straps to the buckle device and for preventing the buckle device from becoming loosened from or relative to the buckle device.

2. Description of the Prior Art

Typical connector devices or buckle devices for coupling or for suspending straps have been developed for coupling two straps together, and comprises a ring or loop for attaching or coupling to a lock device, and the straps are coupled to the loop and the lock device respectively, for allowing the straps to be coupled together by engaging the loop toward the lock device.

For example, U.S. Pat. No. 7,020,933 to Chang, the present applicant, discloses one of the typical buckle devices comprising a strap ring coupled to one of the straps, and a connector frame couple to the other strap, and the strap ring may be attached to the connector frame, and may be selectively locked to the connector frame with a swinging member.

However, the straps may be coupled and secured to the buckle device with the swinging member, and may not be further fastened or tensioned to the buckle device; i.e. the swinging member should be unfastened or released from the connector frame before the straps may be further fastened or tensioned to the buckle device, such that the typical buckle device may not be easily operated by the users or operators.

The present invention has arisen to mitigate and/or obviate the afore-described disadvantages of the conventional connector or buckle devices.

### SUMMARY OF THE INVENTION

The primary objective of the present invention is to provide a buckle device for allowing two straps to be easily and quickly tightened together and for firmly anchoring and positioning the straps to the buckle device and for allowing the straps to be further fastened or tensioned to the buckle device.

In accordance with one aspect of the invention, there is provided a buckle device comprising a base including a chamber formed therein and defined between two side panels and a bottom panel, and including at least one lock notch formed therein, and including a first end and a second end at a lateral direction, a stationary axle straddled between the side panels of the base and spaced from the bottom panel, and located between the first end and the second end of the base, a first strap attached to the first end of the base, an operating arm rotatably attached to the base with the stationary axle, and rotatable between a released position and a locking position, a shaft attached to the operating arm and movable in concert with the operating arm and rotatable around the stationary axle, a latch slidably attached to the operating arm and engageable with the lock notch of the base, to selectively lock the operating arm to the base at the locking position, and a second strap including an intermediate portion engaged around the stationary axle to form a first strap segment and a second strap segment, the shaft being movable and engageable with the intermediate portion of the second strap to force the second strap segment onto the first strap segment and to tighten the second strap to the base and the operating arm when the operating arm is moved toward the base and locked to the base at the locking position with the latch, and the shaft releasing the intermediate portion of the second strap when the operating arm is rotated away from the base to the released position, and when in the locking position, the shaft is located between the stationary axle and the bottom panel of the base, and the shaft is located closer to the second end of the base than the stationary axle, and the stationary axle and the shaft are spaced from each other for a distance “D” at the lateral direction, to allow the first strap segment to be forced onto the second strap segment when the first strap and the second strap are forced away from each other, and to allow the second strap segment to be further pulled by a user and to further tighten the first strap and the second strap.

The operating arm includes two side plates each having a groove formed therein, and the latch includes two side catches slidably engaged through the grooves of the side plates of the operating arm, to guide the latch to slide relative to the operating arm.

The operating arm includes an ear having an aperture formed therein, and the latch includes an extension extended therefrom and slidably engaged through the aperture of the ear of the operating arm, to guide the latch to slide relative to the operating arm.

The operating arm includes an opening formed therein, and the latch includes at least one hand grip extended outwardly through the opening of the operating arm, to allow the latch to be moved relative to the operating arm with the hand grip.

The shaft includes a circular cross section, and the stationary axle may also include a circular cross section to allow the second strap segment to be further pulled by the users or to facilitate the pulling of the second strap segment by the users.

The distance “D” between the stationary axle and the shaft is no greater than a thickness of both the first strap segment and the second strap segment of the second strap.

The base includes a passage formed in the bottom panel to form a first end bar and a second end bar, and the first strap is secured to the first end bar. The second end bar is disposed between the first strap segment and the second strap segment of the second strap.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a buckle device in accordance with the present invention;

FIG. 2 is a perspective view of the buckle device;

FIG. 3 is a cross sectional view taken along lines 3-3 of FIG. 2;

FIG. 4 is an enlarged partial cross sectional view of the buckle device;

FIG. 5 is a cross sectional view similar to FIG. 3, having two straps attached to the buckle device; and

FIGS. 6, 7, 8 are cross sectional views similar to FIG. 5, illustrating the operation of the buckle device.

### DETAILED DESCRIPTION OF THE PREFERRED EMBODIMENT

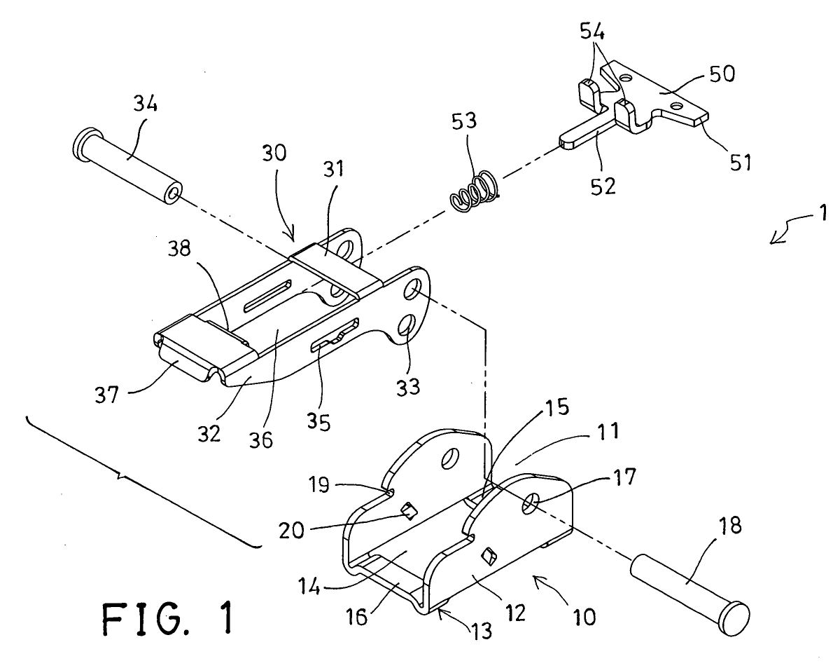

Referring to the drawings, and initially to FIGS. 1-5, a buckle device 1 in accordance with the present invention comprises a base 10 including a chamber 11 formed therein and defined between two side panels 12 and a bottom panel 13, and including a passage 14 formed in the bottom panel 13 thereof for forming or defining two ends or two bars 15, 16, such as a first end or first bar 15 and a second end or second bar 16. Each of the side panels 12 includes an orifice 17 formed therein (FIG. 1) and aligned with each other, to receive a stationary axle 18 therein, and to allow the stationary axle 18 to be supported and straddled between the side panels 12 and to be spaced from the bottom panel 13 and located between the ends 15, 16 of the base 10. The base 10 further includes one or more, such as two lock notches 19 formed therein, such as formed in the side panels 12 thereof respectively, and includes one or more, such as two projections 20 extended inwardly from the side panels 12 respectively.

An operating arm 30 is engaged onto the base 10 or received in the chamber 11 of the base 10, and is rotatably secured to the base 10 with the stationary axle 18, and includes an upper plate 31, and two side plates 32 extended downwardly from and perpendicular to the upper plate 31. The operating arm 30 includes two holes 33 formed in the side plates 32 respectively (FIG. 1) to receive or to attach or to secure a shaft 34 to the operating arm 30, such that the shaft 34 may be moved or rotated in concert with the operating arm 30 and rotatable around the stationary axle 18. The operating arm 30 further includes two grooves 35 formed in the side plates 32 respectively, and includes an opening 36 formed in the middle portion of the upper plate 31, and includes a handle 37 and an ear 38 extended from the upper plate 31, in which the ear 38 includes an aperture 39 formed therein.

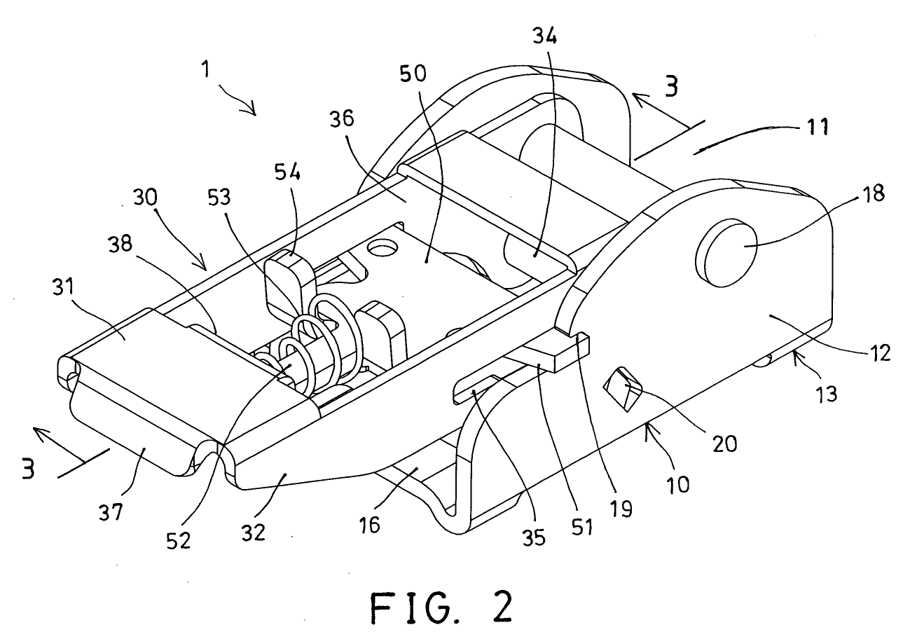

A latch 50 includes two side catches 51 extended therefrom and slidably received in the grooves 35 of the operating arm 30 respectively, to guide and to limit the latch 50 to slide relative to the operating arm 30. The latch 50 may further include an extension 52 extended therefrom and slidably received through the aperture 39 of the ear 38 of the operating arm 30, to further stably guide the latch 50 to slide relative to the operating arm 30. A spring 53 is engaged onto the extension 52 and engaged between the operating arm 30 and the latch 50 to bias the latch 50 away from the ear 38, or to bias the catches 51 to engage into the lock notches 19 of the base 10 respectively (FIG. 2), and thus to lock the operating arm 30 to the base 10 at a locking position.

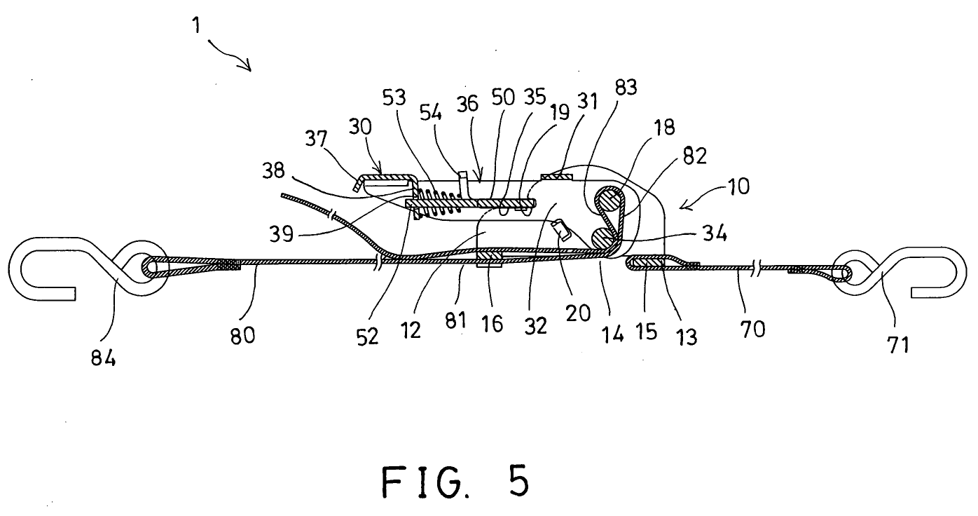

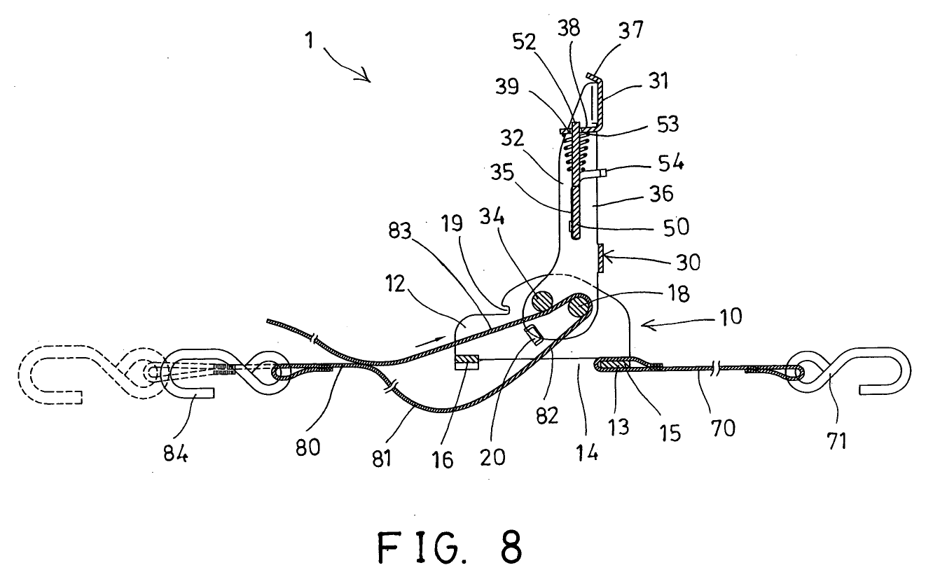

The latch 50 includes one or more hand grips 54 extended therefrom, and extended outwardly through the opening 36 of the operating arm 30, for allowing the latch 50 to be easily moved relative to the operating arm 30, against the spring 53, by the users. As shown in FIGS. 5-8, a strap 70 may be coupled or secured to one of the bars or the first end bar 15 of the base 10, and may be coupled to a hook 71 or the like. Another strap 80 may have an intermediate portion 81 engaged through the passage 14 of the base 10, and engaged around the stationary axle 18 (FIG. 8) for forming two overlapped strap segments 82, 83, such as an outer or first strap segment 82 and an inner or second strap segment 83, and to have the other or second end bar 16 of the base 10 to be disposed between the strap segments 82, 83, in which the outer strap segment 82 is coupled to another hook 84 or the like.

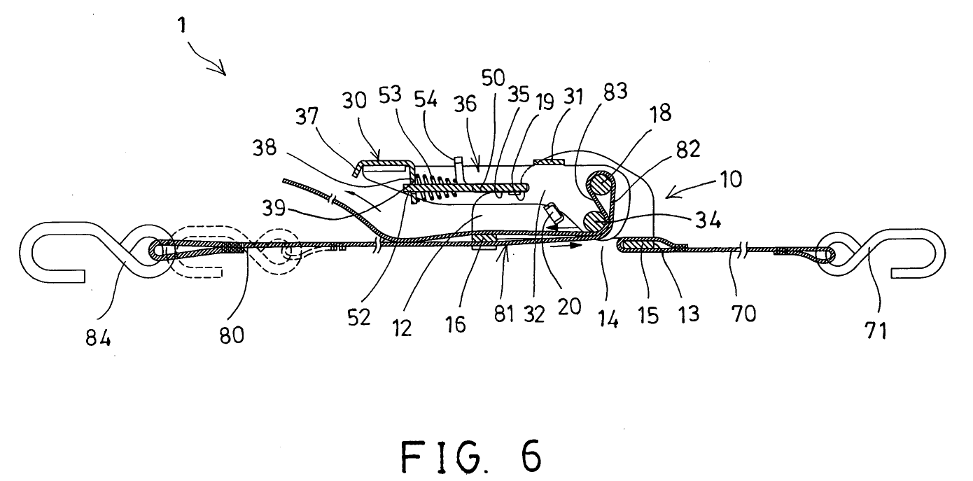

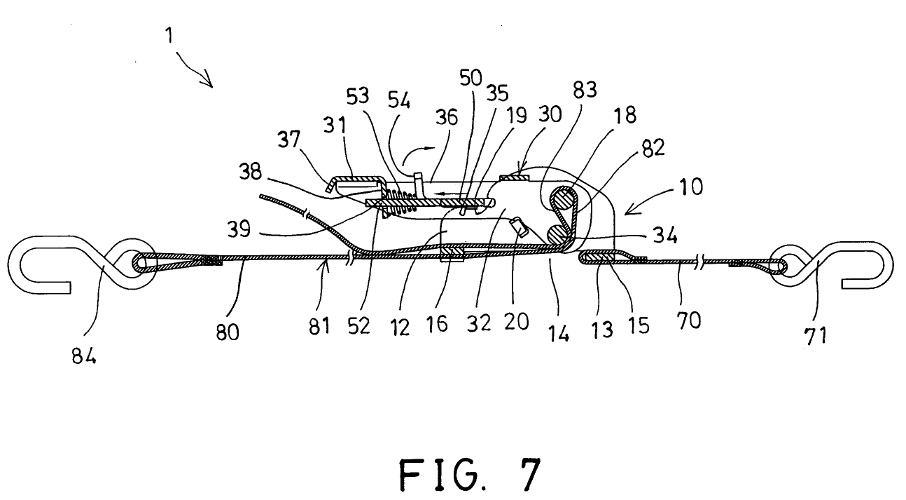

In operation, as shown in FIG. 7, when the catches 51 of the latch 50 are pulled or released or disengaged from the lock notches 19 of the base 10, the operating arm 30 may be rotated away from the base 10 to the released position as shown in FIG. 8, and the shaft 34 may also be rotated or moved away from the intermediate portion 81 of the strap 80 to release the strap 80, and such that the strap 80 may be pulled or tightened relative to the base 10 or the other strap 70 at this moment, by such as pulling either of the strap segments 82, 83 of the strap 80. After the straps 70, 80 or the hooks 71, 84 have been tightened or forced or pulled toward each other by pulling the inner strap segment 83 of the strap 80, the operating arm 30 may then be forced toward the base 10, and may actuate or force the shaft 34 to engage with and to tighten the intermediate portion 81 of the strap 80. The operating arm 30 may then be locked to the base 10 at the locking position by the latch 50 with the lock notches 19 of the base 10 (FIGS. 5, 6).

It is to be noted that, when the operating arm 30 is rotated away from or is released from the base 10 to the released position as shown in FIG. 8, the strap 80 may be easily and quickly pulled and tightened by pulling the inner strap segment 83 of the strap 80, and then the operating arm 30 may be forced toward the base 10 to actuate the shaft 34 to engage with the strap segments 82, 83 of the strap 80, and particularly to force the inner or second strap segment 83 to or against the outer or first strap segment 82, and thus to tighten the intermediate portion 81 of the strap 80. The straps 70, 80 may thus be easily and quickly tightened and locked together by the relative movement between the base 10 and the operating arm 30 and by the latch 50.

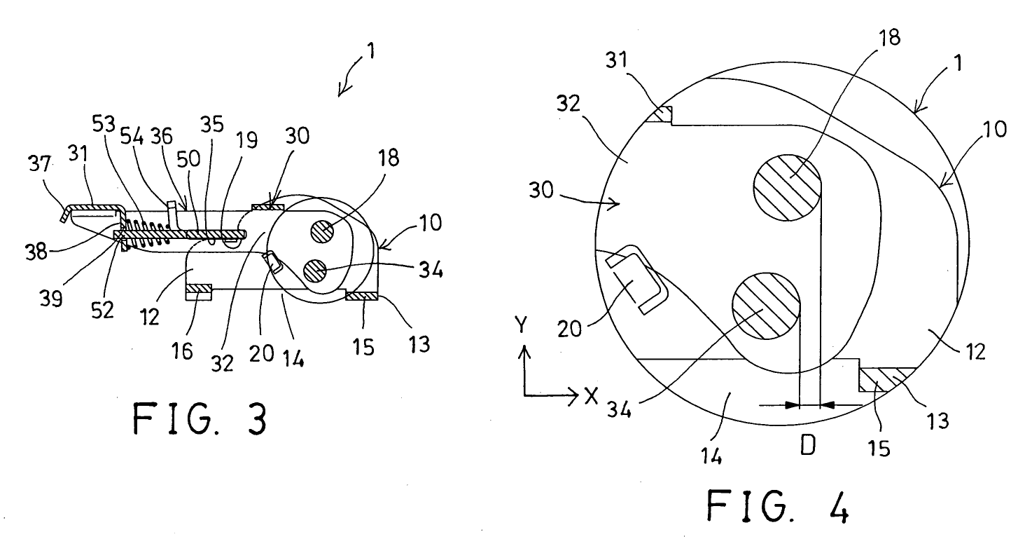

As shown in FIGS. 3-6, when in the locking position, the shaft 34 is moved or rotated to an intermediate position between the bottom panel 13 and the stationary axle 18 of the base 10, and preferably located closer to the bottom panel 13 in the vertical direction or axis Y (FIG. 4), in addition, the stationary axle 18 is located closer to the first end bar 15 of the base 10 than the shaft 34, or the shaft 34 is located closer to the second end bar 16 of the base 10 than the stationary axle 18, and the stationary axle 18 and the shaft 34 are spaced from each other for a distance “D” therebetween at or along the lateral direction or axis X (FIG. 4); the shaft 34 do not move over the stationary axle 18 in the lateral direction or axis X and do not move to an intermediate position between the stationary axle 18 and the first end bar 15.

It is preferable that the distance “D” between the stationary axle 18 and the shaft 34 is no greater than the thickness of both the strap segments 82, 83 of the strap 80 for allowing the inner or second strap segment 83 to be suitably forced onto or against the outer or first strap segment 82 in order to solidly tighten the strap 80 to the operating arm 30 and the base 10. In this arrangement, as shown in FIGS. 5 and 6, when the straps 70, 80 or the hooks 71, 84 are tightened onto the cargo or other objects and when the straps 70, 80 or the hooks 71, 84 are forced or moved away from each other, the outer or first strap segment 82 may be forced toward or onto or against the inner or second strap segment 83 such that the strap segments 82, 83 of the strap 80 will not be unfastened or released from each other.

On the contrary, as shown in FIG. 6, when the inner or second strap segment 83 is pulled away from the operating arm 30 and the base 10 of the buckle device 1, the inner or second strap segment 83 may further be pulled by the users to allow the straps 70, 80 or the hooks 71, 84 to be further tightened by the users. The circular cross section of the stationary axle 18 and the shaft 34 allows the inner or second strap segment 83 to be further pulled by the users or may facilitating the pulling of the inner or second strap segment 83 by the users.

Accordingly, the buckle device in accordance with the present invention may be used for allowing two straps to be easily and quickly tightened together and for firmly anchoring and positioning the straps to the buckle device and for allowing the straps to be further fastened or tensioned to the buckle device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A buckle device comprising:
a base including a chamber formed therein and defined between two side panels and a bottom panel, and including at least one lock notch formed therein, and including a first end and a second end at a lateral direction,
a stationary axle straddled between said side panels of said base and spaced from said bottom panel, and located between said first end and said second end of said base,
a first strap attached to said first end of said base,
an operating arm rotatably attached to said base with said stationary axle, and rotatable between a released position and a locking position,
a shaft attached to said operating arm and movable in concert with said operating arm and rotatable around said stationary axle,
a latch slidably attached to said operating arm and engageable with said at least one lock notch of said base, to selectively lock said operating arm to said base at the locking position, and
a second strap including an intermediate portion engaged around said stationary axle to form a first strap segment and a second strap segment, said shaft being movable and engageable with said intermediate portion of said second strap to force said second strap segment onto said first strap segment and to tighten said second strap to said base and said operating arm when said operating arm is moved toward said base and locked to said base at the locking position with said latch, and said shaft releasing said intermediate portion of said second strap when said operating arm is rotated away from said base to the released position, and
when in the locking position, said shaft being located between said stationary axle and said bottom panel of said base, and said shaft being located closer to said second end of said base than said stationary axle, and said stationary axle and said shaft being spaced from each other for a distance “D” at the lateral direction, to allow said first strap segment to be forced onto said second strap segment when said first strap and said second strap are forced away from each other, and to allow said second strap segment to be further pulled by a user, and to further tighten said first strap and said second strap.

2. The buckle device as claimed in claim 1, wherein said operating arm includes two side plates each having a groove formed therein, and said latch includes two side catches slidably engaged through said grooves of said side plates of said operating arm, to guide said latch to slide relative to said operating arm.

3. The buckle device as claimed in claim 1, wherein said operating arm includes an ear having an aperture formed therein, and said latch includes an extension extended therefrom and slidably engaged through said aperture of said ear of said operating arm, to guide said latch to slide relative to said operating arm.

4. The buckle device as claimed in claim 1, wherein said operating arm includes an opening formed therein, and said latch includes at least one hand grip extended outwardly through said opening of said operating arm, to allow said latch to be moved relative to said operating arm with said at least one hand grip.

5. The buckle device as claimed in claim 1, wherein said shaft includes a circular cross section.

6. The buckle device as claimed in claim 1, wherein said stationary axle includes a circular cross section.

7. The buckle device as claimed in claim 1, wherein said distance “D” between said stationary axle and said shaft is no greater than a thickness of both said first strap segment and said second strap segment of said second strap.

8. The buckle device as claimed in claim 1, wherein said base includes a passage formed in said bottom panel to form a first end bar and a second end bar, and said first strap is secured to said first end bar.

9. The buckle device as claimed in claim 8, wherein said second end bar is disposed between said first strap segment and said second strap segment of said second strap.
